(19) United States
(12) Patent Application Publication
(10) Pub. No.: US 2003/0173520 A1
(43) Pub. Date: Sep. 18, 2003

(54) Method and system for the detection of nerve agents

(75) Inventor: Peter M. Livingston, Palos Verdes Estates, CA (US)

Correspondence Address: PATENT COUNSEL, TRW INC., S & E LAW DEPT., ONE SPACE PARK, BLDG. E2/6051, REDONDO BEACH, CA, 90278, US

(73) Assignee: TRW Inc.

(21) Appl. No.: 10/302,080

(22) Filed: Nov. 22, 2002

Related U.S. Application Data
(63) Continuation of application No. 09/457,100, filed on Dec. 7, 1999, now abandoned.

(51) Int. Cl. G01N 21/35

(52) U.S. Cl. 250/339.13

(57) ABSTRACT

A system for detecting the presence of nerve agents includes a support platform such as a satellite or an aircraft located above and spaced from the surface of the earth. An imaging spectrometer is disposed on the support platform and absorbs radiation emitted from a selected portion of the earth. The imaging spectrometer operates in a plurality of sub-bands in a spectral transmission band from 8 to 14 microns, and measures the spectral intensity present in each sub-band. The spectral intensity in each of the sub-bands is compared to a reference intensity and indicates the presence of the nerve agent when the spectral intensity in a particular sub-band differs from the reference intensity by a preselected amount.

This invention was made with Government support under Agreement No. F04701-98-9-0002 awarded by the U.S. Air Force Space and Missile Systems Center. The Government has certain rights in this invention.

### BACKGROUND OF THE INVENTION

This invention relates generally to detection systems, and more particularly to a method and system for detecting nerve agents in the atmosphere over a wide area.

The problem of detecting the first deployment of a nerve agent from a remote location has been subjected to intense scrutiny in recent years. Various spectroscopic means have been proposed to sense the presence of nerve gas in lethal concentrations, and indeed, the United States Army has deployed such a scheme. However, existing tactical systems are limited by their deployment; they sense the presence or absence of nerve agent only along a well-defined narrow path and can potentially miss gas deployments not in their immediate region. It would be desirable, therefore, to have the ability to sense the presence or absence of nerve agent over a wide area from a remote location.

### SUMMARY OF THE INVENTION

This above omission in the prior art is remedied by the present invention, which places the nerve agent detection monitor on a spacecraft or high-flying aircraft looking down at the battlefield scene. This detector placement requires that the system passively detect the presence or absence of nerve agent, and this is accomplished utilizing the fact that, fortunately, all known nerve agents have a tell-tale absorption spectrum in the far-infrared, just on the edge of the atmosphere transmission window. The system thus operates by placing an imaging spectrometer operating in the eight to fourteen (8-14) micron transmission band of the atmosphere on a spacecraft or aircraft, and measuring the upwelling radiation from the thermal earth in a few spectral subbands of the transmission band. The system then compares the imaged spectral intensity in these subbands for each pixel in its field of view, and indicates the presence of nerve agent by causing line enhancement or line reversal of the pixels in the field of view.

### BRIEF DESCRIPTION OF THE DRAWINGS

Reference in now made to the Description of the Preferred Embodiments, illustrated in the accompanying drawings, in which:

FIG. 1 is a schematic illustration of the system of the present invention, showing the imaging spectrometer located on a satellite and monitoring a preselected portion of the earth;

FIG. 2 is a graph illustrating the absorption spectrum of four common chemical nerve agents; and

FIG. 3 is a schematic diagram illustrating how the earth's blackbody radiation penetrates a band of nerve agent/air mixture.

### DESCRIPTION OF THE PREFERRED EMBODIMENTS

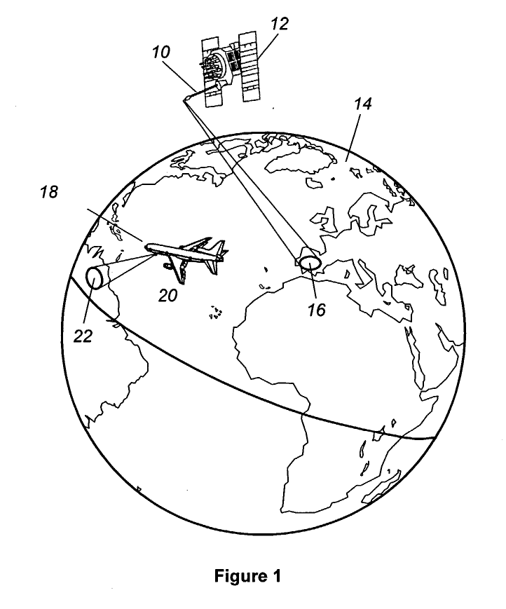

Referring to FIG. 1, it can be seen that an imaging spectrometer 10 is located on a satellite 12 orbiting the earth 14, and has a field of view on a portion 16 of the earth 14 where it is desired to determine if a nerve agent is present. Also illustrated in FIG. 1 is an airplane 18 which can be used as an alternate to, or in conjunction with, the satellite 12. The airplane 18 also has an imaging spectrometer 20 which has its own field of view on a portion of the earth 22.

The imaging spectrometer 10, 20 operates in the 8-14 micron transmission band of the atmosphere and, from its position on the satellite 12 or high-flying aircraft 18 examines the battlefield 16, 22 respectively. The spectrometer 10, for example, measures the upwelling radiation from the thermal earth 14 in a few spectral sub-bands suitably dividing the 8-14 micron transmission band. Thus it can compare the imaged spectral intensity in these sub-bands for each pixel in its field of view 16. The presence of nerve agent will cause a phenomenon called “line enhancement” or “line reversal” over pixels covering the dispersal area. These slightly brighter or darker patches in the appropriate absorption sub-band will not be correlated with terrain features except in a very general way. Moreover the darkening or enhancement of given pixels can be sensitively detected by comparing the upwelling radiation at the same pixel location at wavelengths outside the nerve gas absorption band.

To understand the basic contention underlying this system, two facts need to be established: (1) all nerve gas absorption spectra are similar owing to a peculiar chemical structure, and (2), the layer of gas acts as an absorber or emitter for thermal terrestrial emission depending on its relative temperature compared to the earth's thermal body.

Set forth below is a table showing the molecular structure of four common nerve agents. Each is a relatively simple substituted ether structure with one side chain of which has a phosphorous double-bonded to an oxygen atom.

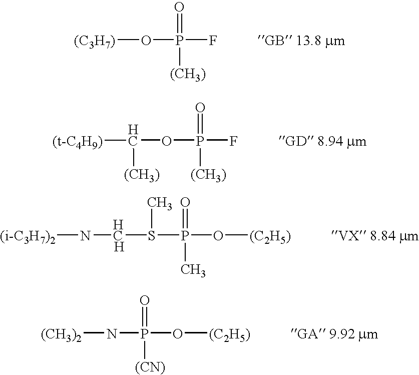

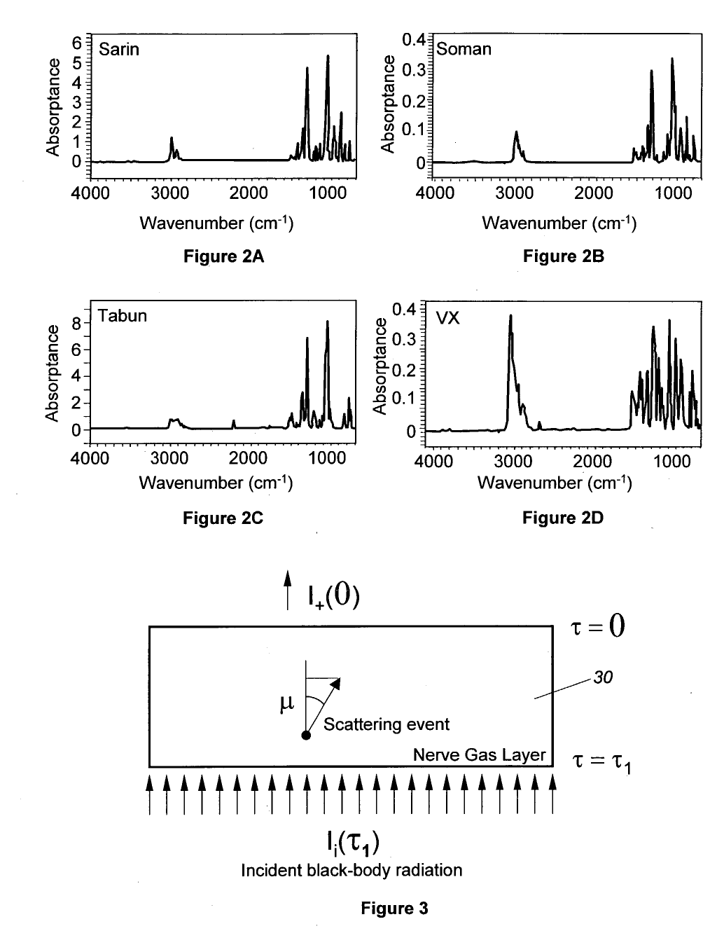

It is this feature that creates the unique infrared absorption signature arising from the phosphorous-oxygen stretch frequencies. At the right side of the table is the common designation for the molecule and its corresponding principal absorption line wavelength. FIG. 2 illustrates gas-phase absorption spectra for these quantities showing the strong P═O stretch frequency absorption, characteristic of these materials. Distribution of these materials as a gas or as an extremely finely divided mist over the battlefield 16 will show up to an imaging spectrometer 10 as anomalous dark or light areas with diffuse edges. These areas should be readily distinguishable from sharply delineated objects such as buildings, tanks, and other battlefield equipment. There will be portions of the atmospheric window spectrum (8-14 microns) essentially transparent to radiation passing through a layer of each gas. These regions of the spectrum will be used to eliminate broad-band emitting or absorbing sources in the spectrometer field-of-view as well as providing a baseline radiance with which to compare the scene values in the gas-absorbing spectral bands.

Detection of these nerve agent concentrations on the earth's surface from orbit 12 or high altitude surveillance aircraft 18 depends on the fact that the dilute poison gas molecules are in equilibrium with the surrounding air, and not with the earth's 300 black-body radiation. This equilibrium is assured by the dominance of collisions between nerve gas molecules and air over radiative losses.

To aid in understanding, suppose that the poison gas or nerve agent occupies a layer, z centimeters thick in air at temperature T_{g} overlying a thermally radiating surface at temperature Tᵣ. Consider the radiation transport problem at frequency ν assumed to be at the center of a significant nerve agent absorption feature such as the P:O stretch frequency (frequencies) common to all nerve gases. Assume further that this portion 16 of the earth 14 is being viewed from space by a telescope with an imaging spectrometer 10 at its focus. Lastly assume that the spectrometer 10 can detect a 1% change in the upwelling earth thermal radiation at the frequency of the poison gas P:O stretch mode.

Let I be the energy flux (watts per cm²), z the layer thickness, and μ=cos Θ be the projection of the flux direction vector on the z axis. Lastly, let S be the source function. It accounts for the possible re-emission of photons before poison gas molecules are thermalized by three-body collisions with air molecules. Hence, it acts as a distributed radiation source throughout the layer. The radiation transport equation reads:

$$\begin{matrix}μ \frac{ⅆ}{ⅆ {τ}_{v}} {I}_{v} ( μ , τ ) = {I}_{v} ( μ , τ ) - {S}_{v} ( τ ) ; \\ {S}_{v} = \frac{{ϵ}_{v}}{{κ}_{v}} ; \\ {τ}_{v} = {\int }_{0}^{z} {κ}_{v} ⅆ x .\end{matrix} \qquad ( 1 )$$

The source function S is the ratio of emission to absorption coefficients and the optical depth τ is the integral over the absorption coefficient as shown. The solutions to this equation in its application to solar photosphere/chromosphere analysis are given in several references. See, for example, J. T. Jeffries, Spectral Line Formation, Blaisdell Publishing Co., Waltham Mass. Another source is S. Chandrasekhar, Radiative Transfer, Dover Publ., New York, 1960.

The source function S depends only on the temperature (in this case, the gas kinetic temperature) for systems in local thermal equilibrium as proven by Kirchoff:

$$S = B ( {T}_{g} ) = \frac{2 h {v}^{3}}{{c}^{2}} {( {ⅇ}^{\frac{h v}{k {T}_{g}}} - 1 )}^{- 1} \qquad ( 2 )$$

It should be understood that the gas temperature often differs from the earth's blackbody temperature. Forced convection is a dominant heat transport mechanism in the atmosphere, overwhelming slow atmosphere thermalization by radiant energy. Assume an adiabatic lapse rate with a fall-off of 10 degrees per kilometer of height. Thus;

$${T}_{g} = {T}_{g} ( 0 ) - {z ( \frac{\partial T}{\partial z} )}_{s} \qquad ( 3 )$$

Combining this equation (3) with equation 2, and following some expansion and re-arrangement, we determine a source term that depends on the optical depth:

$$S = B ( {T}_{g} ( 0 ) ) \cdot [ 1 - \frac{h v}{k {T}_{g} ( 0 )} \frac{{a}^{′} τ}{κ} ] [ \frac{1}{{ⅇ}^{\frac{h v}{k {T}_{g} ( 0 )}} - 1} ] \qquad ( 4 )$$

Here k is the usual Boltzmann constant; h, Planck's constant, and a′ is the lapse rate divided by T_{g}(0) Note that this new transformation dropped the subscript ν on S to simplify the notation.

Having shown this transformation, it is now possible to proceed to a solution of equation (1). However, first note the problem's picture, shown in FIG. 3.

Earth's black body radiation at temperature Tᵣ (300K) penetrates the slab 30 containing the nerve agent. Most absorbed photons at the P:O stretch frequency (frequencies) are thermalized by the rapid three-body collisions between the nerve gas and air molecules. Some photons are re-radiated in random directions giving rise to a random-walk path through the gas. In the present case, the slab 30 is optically thin so that most photons pass through it without absorption/re-radiation. Again, the upper state population of the poison gas remains in thermal equilibrium with the ground state because of the thermostatting effect of the atmosphere.

When equation (4) is combined with equation (1) and the differential equation is solved subject to the condition that no radiation enters from above, then the energy flux density at the top of the slab 30 is:

$$I ( μ , 0 ) = I ( {τ}_{1} , μ ) {ⅇ}^{- \frac{{τ}_{1}}{μ}} + B ( {T}_{g} ) {\int }_{0}^{{τ}_{1}} [ 1 - \frac{h v}{k {T}_{g}} \frac{{a}^{′} t}{κ} ] [ \frac{{ⅇ}^{- \frac{t}{μ}}}{{ⅇ}^{\frac{h v}{k {T}_{g}}} - 1} ] \frac{ⅆ t}{μ} \qquad ( 5 )$$

The integration is simple. Consider only a flux parallel to the z axis since that is what will be gathered by a high flying airplane 18 or a satellite 12. Then expand all exponentials keeping the leading terms because what is sought is the thinnest possible layer visible to the imaging spectrometer 10. Lastly, identify the incident flux with the blackbody function at the radiant temperature, T_{g}. Now the solution to the problem is:

$$\begin{matrix}\frac{δ I}{I} = 1 - \frac{I ( 1 , 0 )}{B ( {T}_{r} )} = {τ}_{1} ( 1 - \frac{B ( {T}_{g} )}{B ( {T}_{r} )} + 3.49 \cdot {10}^{- 8} \frac{B ( {T}_{g} )}{B ( {T}_{r} )} \cdot z ( m ) ) \\ = {τ}_{1} ( 0.08245 + 3.202 \cdot {10}^{- 8} z )\end{matrix} \qquad ( 6 )$$

Equation (6) has the property that for Tᵣ=T_{g} the quantity in the brackets nearly vanishes and would do so if the atmosphere lapse rate had not been taken into account. The second line shows numbers derived using the following values: radiant temperature, 300 K, gas temperature, 293.16 K, adiabatic lapse rate: 10⁻⁴ deg/cm, resonant line center, 723.4 cm⁻¹ (14.8 micron wavelength) for the GB stretch frequency.

From these numbers and the 1% assumption stated at the beginning, it can be determined that;

$${τ}_{1} = \frac{0.1213}{1 - 3.88 \cdot {10}^{- 7} z} . \qquad ( 7 )$$

Assume that κ is constant with altitude over the thin slab containing the gas. Then from the measured GB absorption coefficient of 488 cm⁻¹ and a molecular weight of 140.09; an assumed liquid phase density of 1, it is possible to derive the absorption cross section as 1.4×10⁻¹⁹ cm². From the definition of κ as the product of the number density times the cross section, it can be shown that for a 3000 cm layer, the minimum detectable nerve gas number density is 3.57×10¹⁴ molecules/cm³. Similarly if the layer were only 300 cm thick the minimum detectable concentration increases by two orders of magnitude.

Given that air has an average molecular weight of 29 grams, it follows from the perfect gas law that air at 1 atmosphere at 293.16 K will have 2.5×10¹⁹ average ‘molecules’ per cubic centimeter. Therefore a 1% variation in the absorbing and non-absorbing spectral bands indicates 14.2 ppm of GB in the 30 meter thick layer.

Thus, according to the system set forth above, GB and similar nerve agents are detectable from orbit or high altitude aircraft 18 at moderate concentration levels.

In addition to use of the system during conflict situations where nerve agents may be dispersed into the atmosphere, an alternative use of the system can occur during the initial production of the nerve agents. Since some of these agents are binary compounds that are assembled at time of use, it may be possible to detect the manufacture of these binary agents by examining the effluent of potential manufacturing sites for the tell-tale P:O stretch frequency band. This observation assumes that the binary compound is assembled at the ether bond or other bond, and the P:O double bond resides with one of the binary components.

Therefore, it can be seen that the system of this invention provides for the detection of the presence of nerve agents in the atmosphere in a region of interest from a remote location, while maximizing the potential for detecting the agents.

I claim as my invention:

1. A detection system comprising:
a support platform disposed above and spaced from the surface of the earth;
an imaging spectrometer disposed on the support platform and absorbing radiation emitted from a selected portion of the earth, the imaging spectrometer operating in a plurality of sub-bands in a spectral transmission band from 8 to 14 microns and providing an indication of the spectral intensity present in each sub-band; and
means for comparing the spectral intensity in each of the sub-bands to a reference intensity and for providing an indication when the spectral intensity in a particular sub-band differs from the reference intensity by a preselected amount.

2. The detection system according to claim 1 wherein the spectral intensity in the transmission band is indicative of the presence of a gaseous nerve agent.

3. The detection system according to claim 2 wherein the gaseous nerve agent is a simple substituted ether structure with side chains having a phosphorous double-bond to an oxygen atom.

4. The detection system according to claim 3 wherein the gaseous nerve agent is organic phosphate ether.

5. A method for detecting the presence of a gaseous nerve agent comprising:
absorbing radiation emitted from a selected portion of the earth;
measuring the spectral intensity of the radiation is a plurality of sub-bands within a transmission band of from 8 to 14 microns inclusive;
comparing the spectral intensity in each of the sub-bands with a reference spectral intensity; and
indicating when the spectral intensity absorbed in one of the sub-bands exceeds the reference spectral intensity for that sub-band.
